(19) United States
(12) Patent Application Publication
(10) Pub. No.: US 2009/0081964 A1
(43) Pub. Date: Mar. 26, 2009

(54) METHOD AND SYSTEM FOR PROVIDING VIDEO GAME SOUNDS TO A MOBILE DEVICE

(75) Inventor: Yaron Buznach, Lod (IL)

Correspondence Address: VENABLE LLP, P.O. BOX 34385, WASHINGTON, DC, 20043-9998, US

(73) Assignee: VOLLEE LTD. et al, Herzliya Pitu'ach (IL)

(21) Appl. No.: 12/293,021

(22) PCT Filed: Mar. 15, 2007
(86) PCT No.: PCT/IL07/00344

§ 371 Date: Sep. 15, 2008

(30) Foreign Application Priority Data
Mar. 16, 2006 (IL) 174363

(51) Int. Cl. H04B 1/38

(52) U.S. Cl. 455/90.1

(57) ABSTRACT

The present invention relates to a method and system for managing audio data to be provided to a mobile device user, comprising: (a) one or more video streams with audio data to be run on a streaming server; (b) an audio data database comprising audio data for each video stream, wherein the corresponding audio data is automatically downloaded to user's mobile device and stored therein, upon receiving a command from a user to start running the video stream to which said corresponding audio data is related; (c) a predefined data software component comprising predefined data commands for activating one or more corresponding sounds of the audio data downloaded and stored within said user's mobile device; (d) a receiver for receiving said command from said user to start running the corresponding video stream; (e) a transmitter for transmitting commands to the mobile device to play one or more corresponding sounds of the downloaded audio data, according to the data provided by said predefined data software component; and (f) a control data software component for: (f.1.) controlling providing corresponding audio data to said user's mobile device, according to said command received from said user by means of said receiver; and (f.2.) instructing each mobile device by means of said transmitter to activate one or more sounds of the provided corresponding audio data, according to commands received from said predefined data software component.

### FIELD OF THE INVENTION

The present invention relates to providing audio data to a mobile device. More particularly, the invention relates to a method and system for providing video game sounds to a mobile device user during playing the game.

### BACKGROUND OF THE INVENTION

Recently, the use of mobile devices over the world has increased dramatically. In the every day life, people often use their mobile devices, such as PDAs (Personal Digital Assistants) and cellular phones instead of their PCs (Personal Computers). In addition, more and more users play games on their mobile devices putting aside their PlayStations®, PCs and Laptops. However, for providing to mobile devices users high presentation video and audio quality, especially for high-resolution video games being accompanied by multi-poly audio data, a wide transmission bandwidth is required. The transmission bandwidth is limited for each mobile device, and usually it is not sufficient for providing high quality video and audio data simultaneously. As a result, the video and audio data provided in real-time to mobile devices usually suffers from low presentation quality.

Several solutions have been proposed for overcoming limited bandwidth drawbacks. For example, EP 1,365,386 discloses a method for improving the playing out of digital sound data in an electronic computer system, in particular when the resources for storing and/or loading them are limited, as well as in order to provide a better dynamic management of the digital sound data. The method includes: ad hoc fragmentation of the digital sound file representing the desired sound passage; loading the digital sound fragments into the computer; and playing out or executing the digital sound fragments in a manner controlled suitably by software. The first fragment is downloaded and is played out immediately without waiting for downloading of the second fragment and of the subsequent fragments to be completed, more preferably before starting to download the second fragment and the subsequent fragments. However, EP 1,365,386 relates only to sounds data management and it does not teach providing video data with sounds, such as a video game to a mobile devices user.

Another patent application, WO 01/31497, presents a method for generating an object-oriented interactive multimedia file, including encoding data with at least one video, text, audio, music and/or graphics element, as a video packet stream, text packet stream, audio packet stream, music packet stream and/or graphics packet stream respectively, combining the packet streams into a single self-contained object. However, according to WO 01/31497, the media composition is performed at the server side, and therefore in case of the limited transmission bandwidth the user would still be provided with low presentation quality.

Therefore, there is a continuous need to overcome the prior art drawbacks.

It is an object of the present invention to provide a method and system for efficiently providing video game sounds to a mobile device user during playing the video game, while does not reducing the video presentation quality due to the limited transmission bandwidth.

It is another object of the present invention to provide a method and system for enabling a user to play high-quality video games in real-time.

It is a further object of the present invention to provide a method and system, which are user friendly.

It is still a further object of the present invention to provide a method and system, which are relatively inexpensive.

Other objects and advantages of the invention will become apparent as the description proceeds.

### SUMMARY OF THE INVENTION

The present invention relates to a method and system for providing video game sounds to a mobile device user during playing the game.

The system for managing audio data to be provided to a mobile device user comprises: (a) one or more video streams with audio data to be run on a streaming server; (b) an audio data database comprising audio data for each video stream, wherein the corresponding audio data is automatically downloaded to user's mobile device and stored therein, upon receiving a command from a user to start running the video stream to which said corresponding audio data is related; (c) a predefined data software component comprising predefined data commands for activating one or more corresponding sounds of the audio data downloaded and stored within said user's mobile device; (d) a receiver for receiving said command from said user to start running the corresponding video stream; (e) a transmitter for transmitting commands to the mobile device to play one or more corresponding sounds of the downloaded audio data, according to the data provided by said predefined data software component; and (f) a control data software component for: (f.1.) controlling providing corresponding audio data to said user's mobile device, according to said command received from said user by means of said receiver; and (f.2.) instructing each mobile device by means of said transmitter to activate one or more sounds of the provided corresponding audio data, according to commands received from said predefined data software component.

According to a preferred embodiment of the present invention, the video stream is a video game.

According to another preferred embodiment of the present invention, the control data software component further comprises a game image detection software component for detecting and examining each game image, and for determining the corresponding one or more sounds to be activated within user's mobile device.

According to still another preferred embodiment of the present invention, the control data software component further comprises a game audio detection software component for interacting with a corresponding game instance running within the server and for determining the corresponding one or more sounds to be activated within user's mobile device.

According to a further preferred embodiment of the present invention, the control data software component further examines a binary map of one or more game images for determining the corresponding one or more sounds to be activated within user's mobile device.

The method for providing audio data to a mobile device user comprises: (a) receiving a command from a mobile device user to start streaming video with audio data from a streaming server to the mobile device; (b) automatically downloading to said mobile device and storing therein all audio data required for running said video on said streaming server; (c) starting streaming said video to said mobile device, while said video is running on said streaming server; and (d) activating on said mobile device one or more corresponding sounds within the downloaded audio data, according to commands received from a predefined data software component by means of a transmitter, said predefined data software component comprising predefined data commands for activating said one or more corresponding sounds of the downloaded audio data.

### BRIEF DESCRIPTION OF THE DRAWINGS

In the drawings:

FIG. 1A is a schematic illustration of a system for enabling users to play a video game in real-time on their mobile devices while efficiently utilizing the limited transmission bandwidth, according to a preferred embodiment of the present invention;

FIG. 1B is another schematic illustration of a system for enabling users to play a video game in real-time on their mobile devices while efficiently utilizing the limited transmission bandwidth, according to another preferred embodiment of the present invention; and

FIG. 2 is a schematic block diagram of a Sounds Management System located within a Games Server, according to a preferred embodiment of the present invention.

### DETAILED DESCRIPTION OF THE PREFERRED EMBODIMENTS

Although the following description will be provided with a particular reference to “games”, it will be appreciated by the skilled person that any type of video data (with audio data) that can be, or is desired to be manipulated on a small screen such as that of a mobile device, will benefit from the present invention and is encompassed within it.

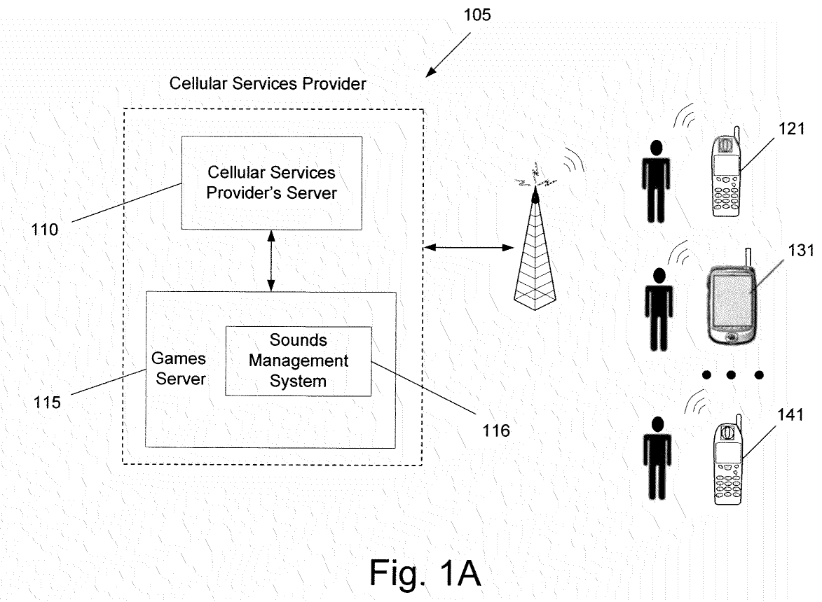

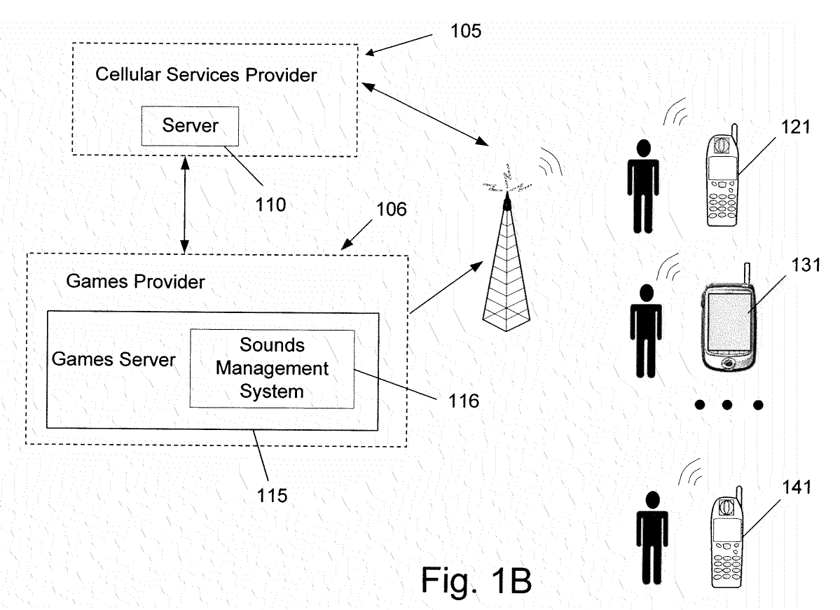

FIG. 1A is a schematic illustration of a system for enabling users to play a video game in real-time on their mobile devices while efficiently utilizing the limited transmission bandwidth, according to a preferred embodiment of the present invention. Cellular Services Provider 105 comprises Server 110 for providing conventional cellular services to mobile devices users (such as cellular phone calls, cellular Internet, SMS (Short Message Service), etc.), and it comprises Games Server 115 for providing games to said users. Games Server 115 comprises one or more video games instances to be played on users' mobile devices, such as cellular phones 121 and 141, PDA (Personal Digital Assistant) 131, etc. The user wishing to play a game on his mobile device connects to Games Server 115 and selects the desired game. Then, the user plays the selected game on his mobile device, while the instance of said game is physically running on said Games Server 115, which is a streaming server. Therefore, the mobile device of said user does not have to comprise high processing resources and large memory means.

According to a preferred embodiment of the present invention, Games Server 115 comprises Sounds Management System 116 for managing sounds (audio data) to be provided to mobile device users. Each game instance comprises its sound data. The user before starting playing a game is automatically provided with all corresponding game sound data, required for playing said game. When Game Server 115 receives from the user a corresponding command to start the game, then the game sound data is automatically downloaded to user's mobile device. The user can be provided, for example, with a message, “The game is loading . . . ”. After it is downloaded and stored within said user's mobile device, the user can start playing the game in real-time. When playing the game, Game Server 115 determines which sound(s) should be played at each game scene (for one or more game frames), and activates one or more corresponding sounds within user's mobile device, which were prior downloaded to said device and stored therein. Since all sounds data is downloaded prior to starting the game, the transmission bandwidth, which is usually limited to each mobile device user, is used more efficiently. The mobile device user is provided in real-time with higher resolution video games, compared to the prior art, by using a larger transmission bandwidth only for transmitting game video data (without audio).

FIG. 1B is another schematic illustration of a system for enabling users to play a video game in real-time on their mobile devices while efficiently utilizing the limited transmission bandwidth, according to another preferred embodiment of the present invention. According to this preferred embodiment, Games Server 115 is separated from Cellular Services Provider 105 and is located within Games Provider 106. Cellular Services Provider 105 uses services of Games Provider 106 to enable its users to play games on their mobile devices. The user wishing to play a game on his mobile device connects to Games Server 115 and selects the desired game. Then, the user plays the selected game on his mobile device, while the instance of said game is physically running on said Games Server 115.

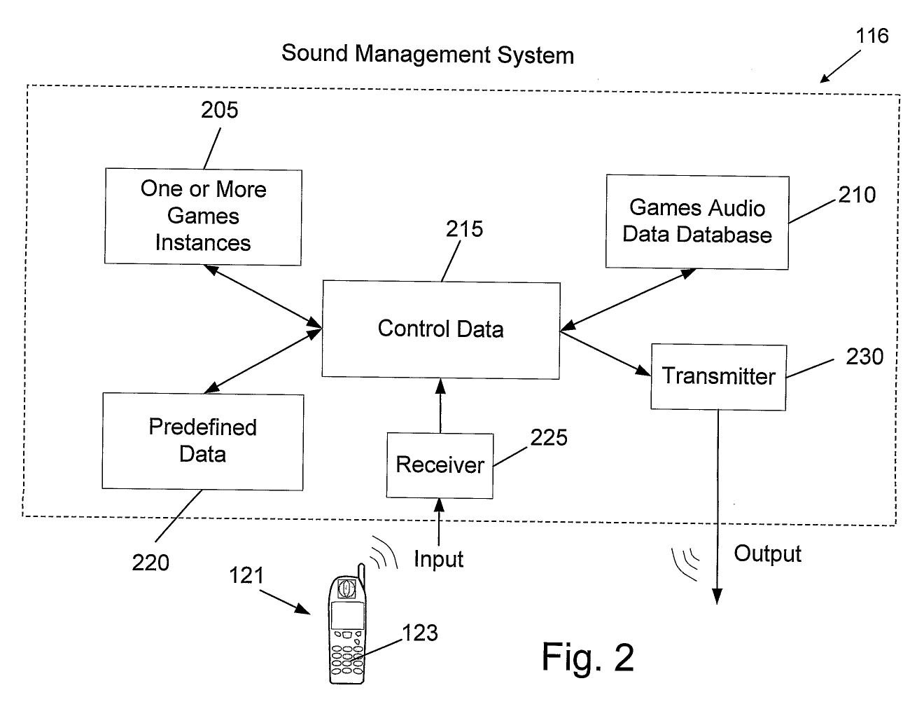

FIG. 2 is a schematic block diagram of Sounds Management System 116 located within Games Server 115, according to a preferred embodiment of the present invention. Sounds Management System 116 comprises one or more games instances 205 running on Games Server 115 (FIG. 1A); control data software component 215 for controlling providing sounds to each mobile device user; predefined data software component 220 comprising commands (instructions) for activating sounds during playing the game; games audio data database 210 comprising downloadable sounds of each game to be played on user's mobile device; receiver 225 for receiving a command from each mobile device user to start playing the corresponding game; and transmitter 230 for transmitting commands (instructions) to each user's mobile device for activating sounds during playing the game (said sounds are downloaded and stored within said each device prior to starting the game). The user before starting playing a game is automatically provided with all corresponding game sound data, required for playing said game. When Game Server 115 receives from the user a command to start a game by means of receiver 225, then the corresponding game sound data is automatically downloaded from games audio data database 210 to the mobile device of said user. When downloading the game sound data, the user can be provided, for example, with a message, “The game is loading . . . ”. After it is downloaded and stored within said user's mobile device, the user can start playing the game in real-time.

Generally, all sounds (audio data) provided to a user during playing a game can be classified to three main categories: (a) background sounds; (b) sounds generated due to pressing one or more buttons on user's mobile device; (c) sounds generated due to a change in a game scene (without user's influence). According to a preferred embodiment of the present invention, each game before being played on a user's mobile device is preprocessed, and the match between all video game scenes (or one or more game frames) and one or more corresponding sounds is determined. Control data software component 215, responsible for controlling providing sounds to the user during the game, “knows” when exactly each sound should be generated (except for the sounds generated by the user by pressing one or more buttons on his mobile device keypad 123). When the user presses one or more buttons on his mobile device keypad 123, one or more corresponding sounds are activated on user's mobile device by means of said device software and/or hardware (the sounds are prior downloaded and stored within said device) without receiving further command(s) from the Game Server. For example, the sound of shooting is activated, when the game hero is pressing on a gun trigger. Otherwise, software component 215 activates one or more corresponding sounds on user's mobile device (within a plurality of prior downloaded and stored sounds), according to the predefined data stored within predefined data software component 220. For example, predefined data software component 220 can send a command to user's mobile device to activate a sound of a working car engine, when the car is moving.

There is a number of preferred embodiments of the present invention for determining when exactly during the game various background sounds and sounds generated due to a change in a game scene should be activated on user's mobile device. According to one preferred embodiment of the present invention, software component 215 comprises a game image detection software component, which is responsible for detecting and examining game images, and for determining accordingly which sound(s) should be activated. For example, if within the inspected image is detected a big red area, then the “explosion” sound should be activated. According to another preferred embodiment of the present invention, control data software component 215 comprises a game audio detection software component that interacts with corresponding game instance 205 (e.g., by receiving/sending sound messages) and determines what sound should be activated at the corresponding moment during paying the game. The game audio detection software component can further detect and examine already activated game sounds and determine accordingly, which subsequent or additional sound(s) should be activated. According to a further preferred embodiment of the present invention, software component 215 examines a binary map of the game image(s) and activates one or more corresponding sounds accordingly. For example, if within the examined binary map, a binary sequence that corresponds to a big red area is detected, then the “explosion” sound should be activated. It should be noted, that all the above preferred embodiments can be combined and used (implemented) together.

While some embodiments of the invention have been described by way of illustration, it will be apparent that the invention can be put into practice with many modifications, variations and adaptations, and with the use of numerous equivalents or alternative solutions that are within the scope of persons skilled in the art, without departing from the spirit of the invention or exceeding the scope of the claims.

1. A system for managing audio data to be provided to a mobile device user, comprising:
a. one or more video streams with audio data to be run on a streaming server;
b. an audio data database comprising audio data for each video stream, wherein the corresponding audio data is automatically downloaded to user's mobile device and stored therein, upon receiving a command from a user to start running the video stream to which said corresponding audio data is related;
c. a predefined data software component comprising predefined data commands for activating one or more corresponding sounds of the audio data downloaded and stored within said user's mobile device;
d. a receiver for receiving said command from said user to start running the corresponding video stream;
e. a transmitter for transmitting commands to the mobile device to play one or more corresponding sounds of the downloaded audio data, according to the data provided by said predefined data software component; and
f. a control data software component for:
f.1. controlling providing corresponding audio data to said user's mobile device, according to said command received from said user by means of said receiver; and
f.2. instructing each mobile device by means of said transmitter to activate one or more sounds of the provided corresponding audio data, according to commands received from said predefined data software component.

2. A system according to claim 1, wherein the video stream is a video game.

3. A system according to claim 2, wherein the control data software component further comprises a game image detection software component for detecting and examining each game image, and for determining the corresponding one or more sounds to be activated within user's mobile device.

4. A system according to claim 2, wherein the control data software component further comprises a game audio detection software component for interacting with a corresponding game instance running within the server and for determining the corresponding one or more sounds to be activated within user's mobile device.

5. A system according to claim 2, wherein the control data software component further examines a binary map of one or more game images for determining the corresponding one or more sounds to be activated within user's mobile device.

6. A method for providing audio data to a mobile device user, comprising:
a. receiving a command from a mobile device user to start streaming video with audio data from a streaming server to the mobile device;
b. automatically downloading to said mobile device and storing therein all audio data required for running said video on said streaming server;
c. starting streaming said video to said mobile device, while said video is running on said streaming server; and
d. activating on said mobile device one or more corresponding sounds within the downloaded audio data, according to commands received from a predefined data software component by means of a transmitter, said predefined data software component comprising predefined data commands for activating said one or more corresponding sounds of the downloaded audio data.

7. A method according to claim 3, further comprising providing a video game as the video stream.

8. A method according to claim 7, further comprising providing a game image detection software component within the control data software component for detecting and examining each game image, and for determining the corresponding one or more sounds to be activated within user's mobile device.

9. A method according to claim 7, further comprising providing a game audio detection software component within the control data software component for interacting with a corresponding game instance running within the server and for determining the corresponding one or more sounds to be activated within user's mobile device.

10. A method according to claim 7, further comprising examining a binary map of one or more game images by means of the control data software component for determining the corresponding one or more sounds to be activated within user's mobile device.

11. (canceled)

12. (canceled)
